(19) United States
(12) Patent Application Publication
(10) Pub. No.: US 2011/0182796 A1
(43) Pub. Date: Jul. 28, 2011

(54) METHOD FOR THE PYROLYSIS OF CARBOHYDRATES

(76) Inventors: Juergen Erwin Lang, Karlsruhe (DE); Alfons Karl, Gruendau (DE); Hartwig Rauleder, Rheinfelden (DE); Ekkehard Mueh, Rheinfelden (DE); Guido Stochniol, Haltern am See (DE)

(21) Appl. No.: 13/121,758

(22) PCT Filed: Sep. 28, 2009
(86) PCT No.: PCT/EP2009/062497

§ 371 Date: Mar. 30, 2011

(30) Foreign Application Priority Data
Sep. 30, 2008 (DE) 10 2008 042 498.6

(51) Int. Cl. C01B 33/025; C01B 33/02

(52) U.S. Cl. 423/350; 423/348

(57) ABSTRACT

The present invention relates to methods for the technical pyrolysis of a carbohydrate or carbohydrate mixture at an elevated temperature while adding silicon oxide, to a pyrolysis product obtainable in this way, and to the use thereof as a reducing agent for the production of solar silicon from silicic acid and carbon at a high temperature.

The present invention relates to an industrial process for pyrolysis of carbohydrates, especially of sugar, to the pyrolysis product thus obtainable and to the use thereof as a reducing agent in the preparation of solar silicon from silica and carbon at high temperature.

It is known that carbohydrates, for example mono-, oligo- and polysaccharides, can be pyrolyzed in gas chromatographs.

U.S. Pat. No. 5,882,726 discloses a process for preparing a carbon-carbon composition, wherein a pyrolysis of a low-melting sugar is performed.

GB 733 376 discloses a process for purifying a sugar solution, and for pyrolysis at 300 to 400° C.

It is likewise known that sugar can be pyrolyzed at high temperature in order to obtain an electron-conductive substance (WO 2005/051840).

In the industrial scale pyrolysis of carbohydrates, there may be problems as a result of caramelization and foam formation, which can considerably disrupt the process regime and the course of the process.

It is also known that sugars and other substances can be used as reducing agents with a small proportion of impurities (U.S. Pat. No. 4,294,811, WO 2007/106860) or as binders (U.S. Pat. No. 4,247,528) in the preparation of pure silicon.

It was an object of the present invention to provide a process for pyrolysis of carbohydrates, especially of sugar, in which foam formation is avoided.

The object is achieved in accordance with the invention according to the information in the claims.

It has thus been found that, surprisingly, addition of silicon oxide, preferably SiO₂, especially precipitated silica and/or fumed silica, can suppress the foam formation effect. Thus, industrial processes for pyrolysis of carbohydrates can now be operated in a simple and economically viable manner also without troublesome foam formation. Furthermore, no caramel formation was observed either in the course of performance of the process according to the invention.

Furthermore, in a preferred embodiment, it was advantageously possible, since it is particularly energy-saving (low-temperature mode), to lower the pyrolysis temperature from, for example, 1600° C. to around 700° C. Thus, the process according to the invention is advantageously conducted above a temperature of 400° C., more preferably at 400 to 700° C. and most preferably at 400 to 600° C. This process is extremely energy-efficient and additionally has the advantage that caramel formation is reduced and the handling of the gaseous reaction products is made easier. Likewise preferably, the reaction can be performed between 800 and 1600° C., more preferably between 900 and 1500° C., especially at 1000 to 1400° C., to advantageously obtain a graphite-containing pyrolysis product. If a graphite-containing pyrolysis product is preferred, a pyrolysis temperature of 1300 to 1500° C. should be pursued. The present process is advantageously performed under protective gas and/or under reduced pressure (vacuum). Thus, the process according to the invention is advantageously performed at a pressure of 1 mbar to 1 bar (ambient pressure), especially of 1 to 10 mbar. Appropriately, the pyrolysis apparatus used is dried before the start of pyrolysis and is purged to virtually free it of oxygen by purging with an inert gas, such as nitrogen or Ar or He. The pyrolysis time in the process according to the invention is generally between 1 minute and 48 hours, preferably between ¼ hour and 18 hours, especially between ½ hour and 12 hours, at said pyrolysis temperature, in which case the heating time until attainment of the desired pyrolysis temperature may additionally be within the same order of magnitude, especially between ¼ hour and 8 hours. The present process is generally performed batchwise; however, it can also be performed continuously.

A C-based pyrolysis product obtained in accordance with the invention comprises carbon, especially with graphite components and silica and optionally components of other carbon forms, such as coke, and is particularly low in impurities, for example B, P, As and Al compounds, The inventive pyrolysis product can thus be used advantageously as a reducing agent in the preparation of solar silicon from silica at high temperature. More particularly, the inventive graphite-containing pyrolysis product can be used in a light arc reactor due to its conductivity properties.

The present invention therefore provides a process for industrial pyrolysis of a carbohydrate or carbohydrate mixture at elevated temperature with addition of silicon oxide.

The carbohydrate components used in the process according to the invention preferably include monosaccharides, i.e. aldoses or ketoses, such as trioses, tetroses, pentoses, hexoses, heptoses, particularly glucose and fructose, but also corresponding oligo- and polysaccharides based on said monomers, such as lactose, maltose, sucrose, raffinose,—to name just a few, or derivatives thereof—up to and including starch, including amylose and amylopectin, the glycogens, the glycosans and fructosans—to name just a few polysaccharides.

If appropriate, aforementioned carbohydrates can additionally be purified by a treatment using an ion exchanger, in which case the carbohydrate is dissolved in a suitable solvent, advantageously water, and conducted through a column filled with an ion exchange resin, preferably an anionic or cationic resin, the resulting solution is concentrated, for example by removing solvent components by heating—especially under reduced pressure—and the carbohydrate thus purified is advantageously obtained in crystalline form, for example by cooling the solution and then removing the crystalline components, by means of methods including filtration or centrifuging.

However, it is also possible to use a mixture of at least two of the aforementioned carbohydrates as the carbohydrate or carbohydrate component in the process according to the invention. Particular preference is given in the process according to the invention to a crystalline sugar available in economically viable amounts, a sugar as can be obtained in a manner known per se, for example, by crystallization of a solution or a juice from sugarcane or beets, i.e. commercially crystalline sugar, for example refined sugar, preferably a crystalline sugar with the substance-specific melting point/softening range and a mean particle size of 1 μm to 10 cm, more preferably of 10 μm to 1 cm, especially of 100 μm to 0.5 cm. The particle size can be determined, for example—but not exclusively—by means of screen analysis, TEM, SEM or light microscopy. However, it is also possible to use a carbohydrate in dissolved form, for example—but not exclusively—in aqueous solution, in which case the solvent admittedly evaporates more or less rapidly before attainment of the actual pyrolysis temperature.

The silicon oxide component used in the process according to the invention is preferably SiOₓ where x=0.5 to 1.5, SiO, SiO₂, silicon oxide (hydrate), aqueous or water-containing SiO₂, in the form of fumed or precipitated silica, in moist, dry or calcined form, for example Aerosil® or Sipernat®, or a silica sol or gel, porous or dense silica glass, quartz sand, quartz glass fibres, for example light guide fibres, quartz glass beads, or mixtures of at least two of the aforementioned components.

Preference is given to using, in the process according to the invention, silica with an internal surface area of 0.1 to 600 m²/g, more preferably of 10 to 500 m²/g, especially of 100 to 200 m²/g. The internal or specific surface area can be determined, for example, by the BET method (DIN ISO 9277).

Preference is given to using silica with a mean particle size of 10 nm to 1 mm, especially of 1 to 500 μm. Here too, the particle size can be determined by means of methods including TEM (transmission electron microscopy), SEM (scanning electron microscopy) or light microscopy.

The silica used in the process according to the invention advantageously has a high (99%) to ultrahigh (99.9999%) purity, and the total content of impurities, such as B, P, As and Al compounds, should advantageously be ≦10 ppm by weight, especially ≦1 ppm by weight. Impurities can be determined, for example—but not exclusively—by means of ICP-MS/OES (induction coupling spectrometry—mass spectrometry/optical electron spectrometry) and AAS (atomic absorption spectroscopy).

For instance, in the process according to the invention, it is possible to use carbohydrate relative to defoamer, i.e. silicon oxide component, calculated as SiO₂, in a weight ratio of 1000:0.1 to 0.1:1000. The weight ratio of carbohydrate component to silicon oxide component can preferably be adjusted to 800:0.4 to 1:1, more preferably to 500:1 to 100:13, most preferably to 250:1 to 100:7.

The apparatus used for the performance of the process according to the invention can, for example, be an induction-heated vacuum reactor, in which case the reactor may be made of stainless steel and, with regard to the reaction, is coated or lined with a suitable inert substance, for example high-purity SiC, Si₃N₃, high-purity quartz glass or silica glass, high-purity carbon or graphite, ceramic. However, it is also possible to use other suitable reaction vessels, for example an induction oven with a vacuum chamber for accommodation of appropriate reaction crucibles or vats.

In general, the process according to the invention is performed as follows:

The reactor interior and the reaction vessel are suitably dried and purged with an inert gas, which may be heated, for example, to a temperature between room temperature and 300° C. Subsequently, the carbohydrate or carbohydrate mixture to be pyrolyzed, as well as the silicon oxide as a defoamer component, is charged into the reaction chamber or the reaction vessel of the pyrolysis apparatus. The feedstocks can be mixed intimately beforehand, degassed under reduced pressure and transferred into the prepared reactor under protective gas. In this case, the reactor may already be slightly preheated. Subsequently, the temperature can be adjusted continuously or stepwise to the desired pyrolysis temperature and the pressure can be reduced in order to be able to remove the gaseous decomposition products which escape from the reaction mixture as rapidly as possible. Especially as a result of the addition of silicon oxide, it is advantageous to very substantially prevent foam formation of the reaction mixture. After the pyrolysis reaction has ended, the pyrolysis product can be thermally aftertreated for a while, advantageously at a temperature in the range from 1000 to 1500° C.

In general, a pyrolysis product or a composition which comprises high-purity carbon is thus obtained. The inventive process product can be used particularly advantageously as a reducing agent for the preparation of solar silicon from silica or high-purity silica. To this end, inventive pyrolysis product can be converted to a defined form with addition of further components, such as pure or high-purity SiO₂, activators such as SiC, binder such as organosilanes, organosiloxanes, carbohydrates, silica gel, natural or synthetic resins, and high-purity processing aids, such as pressing, tableting or extrusion aids, such as graphite, examples of conversion methods including granulation, pelletization, tableting, extrusion—to name just a few examples.

The present invention thus provides a composition or the pyrolysis product as obtained by the process according to the invention.

The present invention therefore likewise provides a pyrolysis product with a content of carbon relative to silicon oxide (calculated as silicon dioxide) of 400:0.1 to 0.4:1000, preferably of 400:0.4 to 4:10; more preferably of 400:2 to 4:1.3; especially of 400:4 to 40:7.

More particularly, the direct process product of the process according to the invention is notable for its high purity and usability for the preparation of polycrystalline silicon, especially of solar silicon for photovoltaic systems, but also for medical applications.

Such an inventive composition (also referred to as pyrolysate or pyrolysis product for short) can be used particularly advantageously as a feedstock in the preparation of solar silicon by reduction of SiO₂ at elevated temperature, especially in a light arc furnace. For instance, the inventive direct process product can be used in a simple and economically viable manner as a C-containing reducing agent in a process as disclosed, for example, in U.S. Pat. No. 4,247,528, U.S. Pat. No. 4,460,556, U.S. Pat. No. 4,294,811 and WO 2007/106860.

The present invention also provides for the use of an inventive composition (pyrolysis product) as a feedstock in the preparation of solar silicon by reduction of SiO₂ at relatively high temperature, especially in a light arc furnace.

The present invention is explained in detail and illustrated by the example which follows and the comparative examples, without restricting the subject-matter of the invention.

### EXAMPLES

### Comparative Example 1

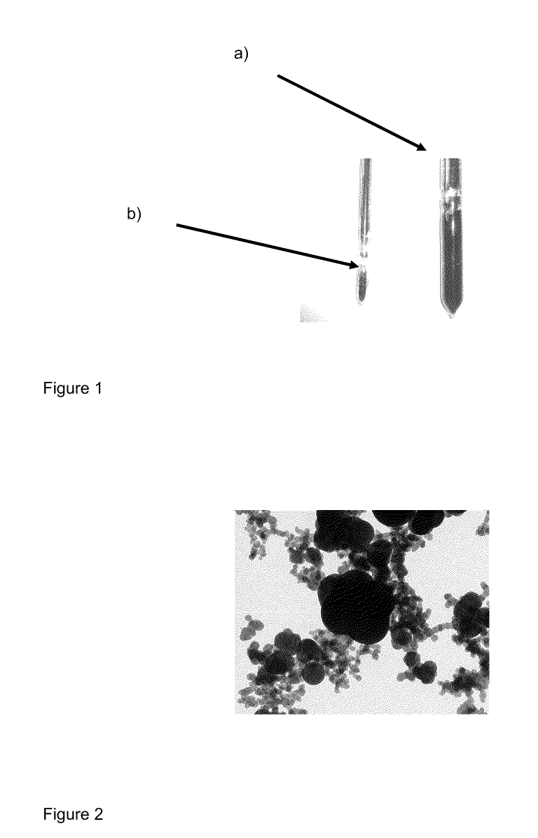

Commercial refined sugar was melted under protective gas in a quartz glass tube and then heated to about 1600° C. The reaction mixture foamed significantly, and some escaped—caramel formation was likewise observed, and the pyrolysis product remained adhering on the wall of the reaction vessel; cf. FIG. 1a).

### Example 1

Commercial refined sugar was mixed with SiO₂ (Sipernat® 100) in a weight ratio of 20:1 (sugar: SiO₂), melted and heated to around 800° C. No caramel formation was observed, nor did any foam formation occur. A graphite-containing particulate pyrolysis product was obtained, which advantageously essentially did not adhere to the wall of the reaction vessel; cf. FIG. 1b) and FIG. 2 (electron micrograph of the pyrolysis product from Example 1).

1. Process for industrial pyrolysis of a carbohydrate or carbohydrate mixture at elevated temperature with addition of silicon oxide.

2. Process according to claim 1, wherein the silicon oxide is at least one silicon dioxide form.

3. Process according to claim 1, wherein the carbohydrate component is at least one crystalline sugar.

4. Process according to claim 1, wherein carbohydrate and silicon oxide (each calculated in total) are used in a weight ratio of 1000:0.1 to 0.1:1000.

5. Process according to claim 1, wherein the pyrolysis is performed in a reactor with exclusion of oxygen.

6. Process according to claim 1, wherein the pyrolysis is performed at a temperature between 400 and 700° C.

7. Process according to claim 1, wherein the pyrolysis is performed at a temperature above 700° C. at a pressure between 1 mbar and 1 bar in an inert gas atmosphere.

8. Composition comprising a pyrolysis product obtained according to the process of claim 1.

9. Pyrolysis product with a content of carbon relative to silicon oxide (calculated as silicon dioxide) of 400:0.1 to 0.4:1000.

10. A feedstock for the preparation of solar silicon by reduction of SiO₂ at relatively high temperature, comprising a pyrolysis product according to claim 8.

11. Process for preparing silicon, wherein a mixture of a carbohydrate, and a silicon oxide, is pyrolysed at temperatures of 400 to 700° C. and wherein the pyrolysis product is subsequently used to prepare high-purity silicon.

12. Process according to claim 2, wherein at least one silicon dioxide is selected from especially fumed or precipitated silica of high to ultrahigh purity.

13. Process according to claim 11, wherein the carbohydrate is purified by means of ion exchange columns.

14. Process according to claim 11, wherein the silicon oxide is a high-purity silicon oxide with a total content of B, P, As and Al compounds of ≦10 ppm by weight.

15. A method for the preparation of solar silicon by reduction of SiO₂ at relatively high temperature, wherein the method comprises a feedstock comprising the pyrolysis product according to claim 8.
